(19) United States
(12) Patent Application Publication
(10) Pub. No.: US 2025/0200603 A1
(43) Pub. Date: Jun. 19, 2025

(54) Blockchain Synchronized Membership Processing Systems

(71) Applicant: Junto Tech Inc., Jersey City, NJ (US)

(72) Inventors: Levi Daniel FRANKLIN, Seattle, WA (US); Benjamin TURTEL, Allenhurst, NJ (US); Kris SKOTHEIM, Arcata, CA (US)

(21) Appl. No.: 18/980,855

(22) Filed: Dec. 13, 2024

Related U.S. Application Data
(60) Provisional application No. 63/609,679, filed on Dec. 13, 2023.

(51) Int. Cl. G06Q 30/0226; G06F 3/04847; G06F 9/445; G06F 21/62

(52) U.S. Cl. CPC G06Q 30/0232; G06F 3/04847; G06F 9/44526; G06F 21/6209; G06Q 2220/00

(57) ABSTRACT

An example computer system for blockchain synchronized membership processing includes memory hardware and processor hardware configured to establish a communication connection with at least one membership system touchpoint, define one or more specified requirements associated with each of multiple membership tiers, grant tokenized memberships to multiple user entities according to user data and the specified requirement(s) associated with each of the multiple membership tiers, determine whether any of the multiple user entities have a changed membership status among the multiple membership tiers, in response to determining that one of the multiple user entities has a changed membership status, update a tokenized membership corresponding to the user entity on a membership status blockchain, and for each of the multiple user entities, grant access to one or more resources via token gating, according to one of the multiple membership tiers associated with a tokenized membership of the user entity.

### CROSS-REFERENCE TO RELATED APPLICATION

This application claims the benefit and priority of U.S. Provisional Application No. 63/609,679, filed on Dec. 13, 2023. The entire disclosure of the above application is incorporated herein by reference.

### FIELD

The present disclosure relates to synchronized membership processes for blockchain systems.

### BACKGROUND

Current approaches to blockchain loyalty are mostly disconnected from existing loyalty programs or member touchpoints. These systems typically require a large migration from the brand, or the sale of new non-fungible tokens (NFTs) to originate new memberships in the new web3 membership program. This is insufficient for many brands who would like to tap into some of the benefits of web3 memberships (such as integration-free partnerships and token-gated applications), but want to continue to engage customers on existing touchpoints, do not expect many customers to convert to a fully-web3 program, or do not want to rebuild from scratch.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An example computer system for blockchain synchronized membership processing includes memory hardware configured to store blockchain data including a membership status blockchain, membership tier data including multiple membership tiers, membership token data including tokenized memberships each associated with one of multiple user entities, and computer-executable instructions. Processor hardware is configured to execute the computer-executable instructions to establish a communication connection with at least one membership system touchpoint, define, in the membership tier data, one or more specified requirements associated with each of the multiple membership tiers, grant tokenized memberships to multiple user entities according to user data associated with the multiple user entities, and the one or more specified requirements associated with each of the multiple membership tiers, determine whether any of the multiple user entities have a changed membership status among the multiple membership tiers according to the one or more specified requirements, in response to determining that one of the multiple user entities has a changed membership status, update a tokenized membership corresponding to the one of the multiple user entities having the changed membership status, on the membership status blockchain of the blockchain data, and for each of the multiple user entities, grant access to one or more resources via token gating, according to one of the multiple membership tiers associated with a tokenized membership of the user entity.

In some examples, the processor hardware is configured to execute the computer-executable instructions to repeat checking whether any of the multiple user entities have a changed membership status among the multiple membership tiers, on a periodic interval. In some examples, the periodic interval includes at least one of a daily interval and a weekly interval.

In some examples, the one or more specified requirements for the multiple membership tiers include at least one of ownership of one or more specified non-fungible tokens (NFTs), a following status on a social media account associated with the multiple membership tiers, a specified number of points obtained from defined quests associated with the multiple membership tiers, a subscription active status for a subscription service associated with the multiple membership tiers, completion of a specified purchase associated with the multiple membership tiers, or confirmed attendance at an event associated with the multiple membership tiers.

In some examples, the processor hardware is configured to execute the computer-executable instructions to define at least one quest represented by one or more actions executed by each one of the multiple user entities, wherein each quest specifies at least one of a number of points that will be granted to one of the multiple user entities upon completion of the quest, a limit on whether the quest may be repeated, or a time period between successive completions of the quest.

In some examples, the processor hardware is configured to execute the computer-executable instructions to display one or more widgets on a user interface to facilitate changing system settings by a client user. In some examples, the one or more widgets include at least one of a membership onboarding widget configured to connect at least one of an email account associated with one of the multiple user entities, a blockchain wallet associated with one of the multiple user entities, or a social media account associated with one of the multiple user entities a member dashboard widget configured to display at least one of membership tier information, points information, and steps needed to advance membership tiers, a quests widget configured to identify determined actions for one of the multiple user entities to take to earn a specified number of points, a leaderboard widget configured to display some of the multiple user entities on a leaderboard, or a forms widget configured to collect information from one of the multiple user entities. In some examples, the one or more widgets include all of the membership onboarding widget, the member dashboard widget, the quests widget, the leaderboard widget and the forms widget.

In some examples, the processor hardware is configured to execute the computer-executable instructions to adjust a number of non-fungible tokens (NFTs) held by one of the multiple user entities by burning at least one NFT and sending at least one new NFT to the one of the multiple user entities according to the one or more specified requirements associated with each of the multiple membership tiers. In some examples, the multiple membership tiers are hierarchical and a single smart contract is linked for each one of the multiple user entities to facilitate token gating for each one of the multiple user entities.

In some examples, the processor hardware is configured to execute the computer-executable instructions to create and store a blockchain wallet for identifying membership in an organization, and the blockchain wallet includes a combination of a private key and a public key.

In some examples, the processor hardware is configured to execute the computer-executable instructions to establish the communication connection with the at least one membership system touchpoint by plugging into a web application associated with the at least one membership system touchpoint.

In some examples, the processor hardware is configured to execute the computer-executable instructions to evaluate information of each of the multiple user entities by executing an authentication check and application programming interface (API) integration with one or more external systems.

In some examples, the processor hardware is configured onboard a new user entity by receiving a message satisfying an ERC-4361 standard to prove that the new user entity owns a blockchain wallet, and executing a blockchain query to determine if user information of the new user entity satisfies specified member action definitions.

In some examples, the processor hardware is configured to execute the computer-executable instructions to implement the token gating by determining whether one of the multiple user entities has a specified threshold number of non-fungible tokens (NFTs) corresponding to a level of requested access.

An example computerized method for blockchain synchronized membership processing includes establishing a communication connection with at least one membership system touchpoint, defining, in membership tier data, one or more specified requirements associated with each of multiple membership tiers, granting tokenized memberships to multiple user entities according to user data associated with the multiple user entities, and the one or more specified requirements associated with each of the multiple membership tiers, determining whether any of the multiple user entities have a changed membership status among the multiple membership tiers according to the one or more specified requirements, in response to determining that one of the multiple user entities has a changed membership status, updating a tokenized membership corresponding to the one of the multiple user entities having the changed membership status, on a membership status blockchain, and for each of the multiple user entities, granting access to one or more resources via token gating, according to one of the multiple membership tiers associated with a tokenized membership of the user entity.

In some examples, the method includes repeating checking of whether any of the multiple user entities have a changed membership status among the multiple membership tiers, on a periodic interval, wherein the periodic interval includes at least one of a daily interval and a weekly interval.

In some examples, the method includes adjusting a number of non-fungible tokens (NFTs) held by one of the multiple user entities by burning at least one NFT and sending at least one new NFT to the one of the multiple user entities according to the one or more specified requirements associated with each of the multiple membership tiers.

In some examples, the token gating is implemented by determining whether one of the multiple user entities has a specified threshold number of non-fungible tokens (NFTs) corresponding to a level of requested access.

An example non-transitory computer-readable medium storing instructions that, when executed by at least one processor, cause the at least one processor to establish a communication connection with at least one membership system touchpoint, define, in membership tier data, one or more specified requirements associated with each of multiple membership tiers, grant tokenized memberships to multiple user entities according to user data associated with the multiple user entities, and the one or more specified requirements associated with each of the multiple membership tiers, determine whether any of the multiple user entities have a changed membership status among the multiple membership tiers according to the one or more specified requirements, in response to determining that one of the multiple user entities has a changed membership status, update a tokenized membership corresponding to the one of the multiple user entities having the changed membership status, on a membership status blockchain, and for each of the multiple user entities, grant access to one or more resources via token gating, according to one of the multiple membership tiers associated with a tokenized membership of the user entity.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system for blockchain synchronized membership processing.

FIG. 2 is a flowchart depicting an example process for managing synchronized membership processes on-chain.

FIG. 3 is an illustration of example features of the blockchain synchronized membership management system of FIG. 1.

FIG. 4 is an illustration of example membership tiers of the blockchain synchronized membership system of FIG. 1.

FIG. 5 is an illustration of example widgets of a user interface for controlling a blockchain synchronized membership management system.

In the drawings, reference numbers may be reused to identify similar and/or identical elements.

### DETAILED DESCRIPTION

In some example embodiments described herein, a blockchain synchronized membership management system may be configured to maintain on-chain memberships in sync with existing systems and member touchpoints, which allows brands to access web3 capabilities without a migration or originating new memberships as NFTs. The blockchain synchronized membership management may allow brands to drive engagement across member touchpoints with no-code rules for gamification, points, membership tiers, etc.

Example blockchain managed memberships may be updatable, such that memberships can be bumped up, down, revoked, etc., based on rules defined by the client. The system may regularly keep on-chain memberships in-sync with membership requirements and activations over time, such as by performing a synchronization update at periodic intervals (e.g., every day, every week, etc.). For example, on-chain memberships may be kept in-sync with a member's Substack subscription status, where if a subscriber unsubscribes, their membership NFT is revoked, and they lose access to token-gated spaces. The system may use soulbound, dynamic, non-transferable assets to represent memberships. As another example, various implementations may facilitate management of customers earning points to move up tiers, such as allowing customers to earn points in a variety of ways (e.g., social posts, in-store or digital purchases, application usage, etc.), where achieving specified thresholds advances the customer to a determined tier of membership.

### Blockchain Synchronized Membership Management System

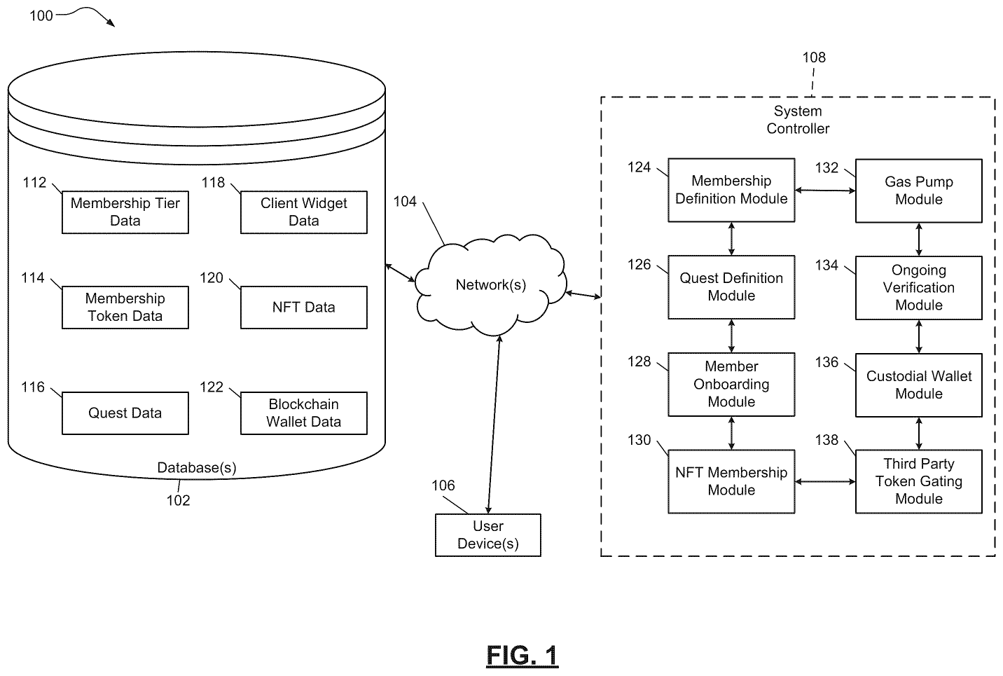

FIG. 1 is a functional block diagram of an example system 100 for synchronized membership management processing via blockchain, which includes one or more databases 102. While the system 100 is generally described as being deployed in a computer network system, the database 102 and/or components of the system 100 may otherwise be deployed (for example, as a standalone computer setup). The system 100 may include a desktop computer, a laptop computer, a tablet, a smartphone, etc.

As shown in FIG. 1, the database(s) 102 store membership tier data 112, membership token data 114, quest data 116, client widget data 118, non-fungible token (NFT) data 120, and blockchain wallet data 122. In various implementations, the database(s) 102 may store other types of data as well.

The membership tier data 112, membership token data 114, quest data 116, client widget data 118, non-fungible token (NFT) data 120, and blockchain wallet data 122 may be located in different physical memories within the database 102, such as different random access memory (RAM), read-only memory (ROM), a non-volatile hard disk or flash memory, etc. In some implementations, the membership tier data 112, membership token data 114, quest data 116, client widget data 118, non-fungible token (NFT) data 120, and blockchain wallet data 122 may be located in the same memory (such as in different address ranges of the same memory). In various implementations, the membership tier data 112, membership token data 114, quest data 116, client widget data 118, non-fungible token (NFT) data 120, and blockchain wallet data 122 may each be stored as structured or unstructured data in any suitable type of data store.

As described further below, the membership tier data 112 may include any suitable data related to various membership tiers, such as requirements for reaching different membership tiers (e.g., bronze tier, silver tier, gold tier, platinum tier, etc.). Example requirements may include, but are not limited to, ownership of an NFT, a status of following on social media, a specified number of points from guests (e.g., 100 points), subscribing on Substack, in-store or digital purchases, attending events, etc. Rules may be combined using, e.g., Boolean-style logic, to support more sophisticated requirements.

The membership token data 114 may include any suitable data related to membership tokens. For example, membership tokens may be granted, managed, maintained, etc. on-chain, and may be used to grant exclusive access with token gating. Example token gated exclusive access opportunities may include, but are not limited to, exclusive discord channels, partner discounts, gated content, event tickets, etc.

The quest data 116 may include any suitable data related to “quests” that members may perform for gaining points or other rewards from an organization. For example, organizations may define quests that are represented by member actions. A quest may specify a number of points that will be granted upon completion of the quest, limits on whether the quest may be repeated, a time period between successive completions of the quest, etc. In various implementations, a quest mechanism may include referrals, such as referring friends to join or become customers. Referral links may be tracked to reward the referrer with points in a program, etc.

In some example embodiments, rewards may be provided to a member for specified actions. For example, a content creator (e.g., a musician, an influencer, etc.), or any other suitable entity, individual or organization, may provide rewards for defined activities such as attending a concert, listening to a specified song on a music streaming service, following an account on another service, etc.

The client widget data 118 may include any suitable data related to widgets that may be applied to a user interface of a computing device display (such as a user device 106), in order to allow a user to interact with the system 100 to change settings, etc. For example, a client may use one or more widgets to onboard members, grant memberships, complete quests to earn points (which can be used to move up membership tiers, etc.).

In various implementations, a member onboarding widget may include a form for connecting various identities, such as email, wallets, socials, etc. A member dashboard widget may display membership tier information, points information, next steps needed to advance tiers, etc. A quests widget may identify determined actions for the user to take in order to earn a specified number of points, which may include submitting evidence for review (such as a photo). A leaderboard widget may display members on a leaderboard, and display information such as a number of points and tier achieved for each member, in order to incentivize competition. A forms widget may include general forms for collecting information, whitelists, etc., and may be completed as a quest. All of the widgets may be customizable, have different style options, be embedded in a client website or application, etc. The example widgets described herein are for purposes of illustration, and various implementations may include more or less widgets, and other types of widgets.

The NFT data 120 may include any suitable data related to NFTs, such as data associated with blockchain membership management. For example, membership NFTs may be soulbound (e.g., cannot be transferred by the owner), and the system 100 may be configured to adjust the number of each NFT that members have by burning NFTs and sending new NFTs based on, e.g., membership tier definitions of an organization. NFT memberships are dynamic, and may be updated periodically to represent membership tiers on-chain.

The blockchain wallet data 122 may include any suitable data related to blockchain wallets, such as membership blockchain wallets and custodial wallets. For example, when an organization creates a membership, a blockchain wallet (e.g., private/public key) may be generated on behalf of the membership and stored in a secure manner. When a user signs in to a membership program, a custodial blockchain wallet may be generated on their behalf, which may be tied to an email or other authorization sign in such as Google or a social media account.

As shown in FIG. 1, a system controller 108 may include one or more modules, including a membership definition module 124, a quest definition module 126, a member onboarding module 128, an NFT membership module 130, a gas pump module 132, an ongoing verification module 134, a custodial wallet module 136, and a third party token gating module 138. These example modules are provided for purposes of illustration, and other embodiments may include more or less modules, functions of different software features implemented in other modules or controller locations, more than one system controller, more than one database, data distributed to other databases, etc.

The membership definition module 124 may include a web application where organizations can connect their various touchpoints, and flexibly define a number of membership tiers. Each tier may have a set of MemberActions that users must complete to qualify for that tier. These MemberActions may include, for example, connecting on social media, filling out a survey, installing an app, holding a certain amount of an ERC20 token, holding an NFT, making an in-store or digital purchase, holding enough quest points, etc.

Organizations may also define how many Membership NFTs each tier should be represented by. The membership definition module 124 may allow organizations to define a flexible combination of MemberActionDefinitions by, for example, using combinations of Boolean operators such as AND/OR/NOT. In various implementations, membership tiers may be defined using a no-code interface. Tiers may have requirements, such as a need to connect a specific social media account type, a need to own a specified NFT, a need to achieve 1000 quest points, etc.

Tiers may be represented by adjusting a balance of NFTs under the hood. For example, the tiers may be inherently hierarchical, where any token gating system can acknowledge letting in a specific tier level or above, while preventing access to tiers below. This may be facilitated via a single smart contract, instead of needing to link multiple smart contracts for different tiers.

In addition to membership tier definitions, the quest definition module 126 may allow organizations to define “quests”, which may be represented by MemberActions. A quest has a number of points that the quest will earn the user upon completion.

Quests may specify whether the quest is performed once or is recurring, and how often the quest may be completed if recurring. In various implementations, the overall number of points that a user achieves may factor into tier membership as a MemberAction.

The member onboarding module 128 may include a web application where potential members can view the membership tier requirements, connect their social media information, and complete MemberActions. The outcomes of these inputs may be evaluated to determine if the user qualifies for a specific membership tier.

In various implementations, evaluating a user's information may include oauth and application programming interface (API) integrations with various providers such as social media companies, Discord, etc. The member onboarding module 128 may require signing a message satisfying an ERC-4361 standard to prove the that the user owns a blockchain wallet. The member onboarding module 128 may then query the blockchain to determine if the user information satisfies the MemberActionDefinitions that the organization set up (e.g., via the membership definition module 124).

The NFT membership module 130 may be configured to grant Membership NFTs which are soulbound (e.g., cannot be transferred by the holder). The NFT membership module 130 may retain the ability to adjust the number of each NFT that members have by, for example, burning and sending new NFTs based on organization membership tier definitions.

In some example embodiments, the NFT membership module 130 may use Unlock Protocol to create and manage these memberships. This allows the NFT membership module 130 to burn NFTs. It also allows the NFT membership module 130 to provide dynamic metadata that returns a different NFT image and other metadata information depending on which membership tier a member is currently on.

In various implementations, at the time of querying the blockchain for an NFT's metadata (such as an image), the NFT membership module 130 may evaluate how many NFTs a member holds, and return the relevant membership tier image defined by the organization. This is different than static image NFTs which have a static image that does not change.

When an organization creates a membership, the gas pump module 132 (or any other module) may be configured to create a blockchain wallet (which may include a private/public key combination) on behalf of the membership, and store the blockchain wallet in a secure manner.

In some example embodiments, organization may send MATIC to cover gas for minting NFTs and doing other blockchain transactions on the polygon network. The gas pump module 132 may then adjust members' membership status through burning or airdropping NFTs. It may also be used to airdrop new membership NFTs immediately, when a user first fills out a form to enter the program.

The ongoing verification module 134 may be configured to reevaluate qualifications of all members periodically, to see which membership tier each member currently qualifies for. For example, the reevaluation may be performed at a regular interval, such as once a week to minimize gas costs. If a member is no longer successfully completing the MemberActions that were defined for the current membership tier, or the MemberAction definitions have changed. the ongoing verification module 134 may be configured to adjust a member's membership level by, e.g., burning or airdropping new membership NFTs to bring move the member to the appropriate membership tier.

When a user signs in to the membership program, the custodial wallet module 136 may be configured to generate a blockchain wallet on their behalf. The blockchain wallet may be tied to the user's email, other oauth sign in such as Google or a social media account, etc.

When the system 100 adjusts token values, adjustments may be made in the “custodial wallet”, and users can view or take ownership of their wallet using their email, etc. The custodial wallet module 136 may also connect to existing web3 solutions using, e.g., “wallet connect,” which the system 100 may be integrated with.

For example, the system 100 may create a wallet on behalf of a client, who can add credit to the wallet. The wallet may then be used to grant membership NFTs on-chain, upgrade membership NFTs, downgrade membership NFTs, etc. This approach may provide advantages such as avoiding a need for members to pay gas fees, and continuously synchronizing memberships without a client triggering each change.

The third party token gating module 138 may be configured to facilitate using the NFTs to prove membership in a community on other third party applications. For example, token gating solutions that require proving that a user holds a certain number of NFTs would be able to utilize these membership tokens, to provide elevated access to these members. Additionally, the third party token gating module 138 may provide SDKs to help custodial wallet members implement the same sort of gating, without having to export their wallet into a third party tool like Metamask. An advantage of the system 100 implementing blockchain-based membership is that the client does not need assistance with token gating, because once memberships are on-chain, the system 100 may work with any other token-enabled tool, since all have access to the same blockchain data.

Users may access one or more modules of the system controller 108 via the user device 106. For example, user device 106 may include any suitable user device for displaying text and receiving input from a user, including a desktop computer, a laptop computer, a tablet, a smartphone, etc. In various implementations, the user device 106 may access the database 102 or the system controller 108 directly, or may access the database 102 or the system controller 108 through one or more networks 104. Example networks may include a wireless network, a local area network (LAN), the Internet, a cellular network, etc.

The network(s) 104 may be used to implement one or more aspects of the blockchain. In various implementations, a blockchain may include a distributed ledger with a growing list of records (e.g., blocks) that are securely linked together via cryptographic hashes. Each block may contain a cryptographic hash of the previous block, a timestamp, and transaction data. Since each block contains information about the previous block, they effectively form a chain, with each additional block linking to the ones before it. Blockchains may be managed by a peer-to-peer (P2P) computer network for use as a public distributed ledger, where nodes collectively adhere to a consensus algorithm protocol to add and validate new transaction blocks.

### Blockchain Syncronized Membership Management Process

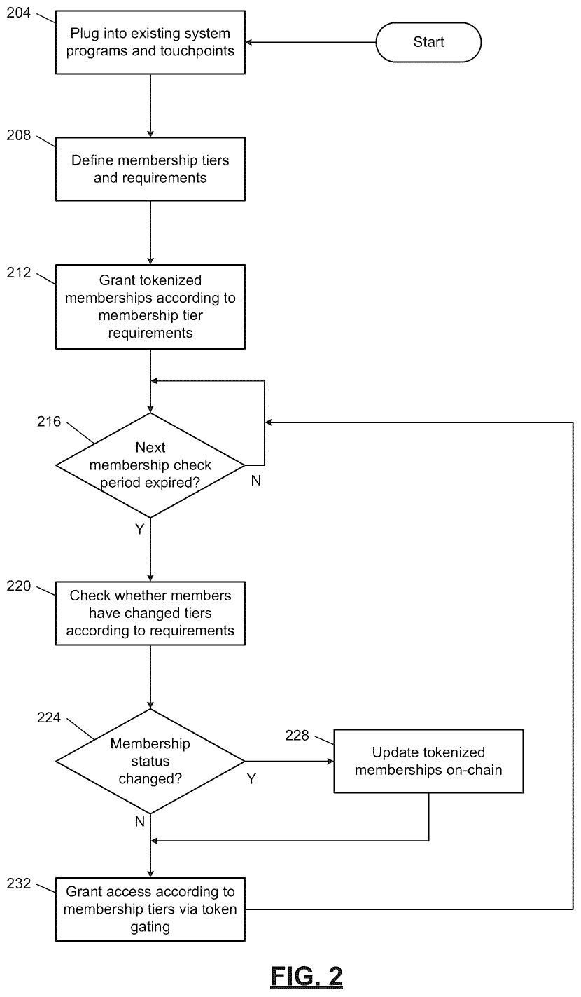

FIG. 2 is a flowchart depicting an example process synchronized membership management processing via blockchain, which may be implemented by, e.g., the system controller 108 of FIG. 1. The process begins at 204 by plugging into existing system programs and touch points (e.g., of an existing membership program of an organization).

At 208, the controller is configured to define membership tiers and requirements. For example, brands, communities, etc. may use no-code rules to define membership tiers, and requirements for each membership tier. For example, membership tier requirements may include ownership of an NFT, following the organization on social media, a specified number of points obtained from quests, subscribing on Substack, etc. Rules may be combined with Boolean-style logic to support more sophisticated requirements.

At 212, the controller is configured to grant tokenized memberships according to membership tier requirements. For example, tokenized memberships may be granted, managed, and maintained on-chain by the system controller 108. The system controller 108 may be configured to regularly check membership tier requirements and update membership tiers, which may include moving members to different tiers as necessary.

The controller is configured to determine whether a next membership check period has expired, at 216. For example, the membership checks may be scheduled at periodic intervals, such as once an hour, once a day, once a week, etc.

Once the next membership period has expired, control proceeds to 220 to check whether members have changed tiers according to the membership tier requirements. If so, control updates tokenized memberships on-chain at 228.

After updating the tokenized memberships on-chain at 228, or determining at 224 that no membership statuses have changed, control proceeds to 232 to grant access according to membership tiers via token gating. For example, membership tokens may be used to grant exclusive access with token gating, and access can be different for every membership tier. Some examples of access include, but are not limited to, exclusive discord channels, partner discounts, gated content, event tickets, etc.

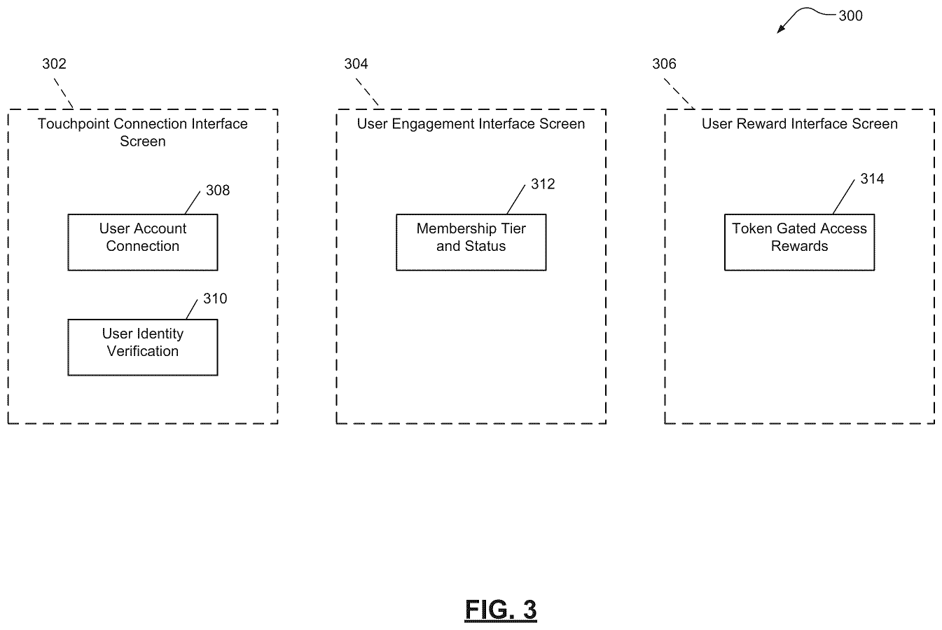

FIG. 3 is an illustration of example features 300 of the blockchain synchronized membership management system of FIG. 1. For example, the system 100 may facilitate identification of every touchpoint in a customer system, and automatically connect the system 100 with those touchpoints.

The system 100 may facilitate engagement of members, to drive continuous activations and offset rising customer acquisition costs. As described above, token based gating may allow for implementation of exclusive rewards (e.g., based on membership tiers and corresponding tokens), for increased customer lifetime value.

FIG. 3 illustrates an example touchpoint connection interface screen 302. The touchpoint connection interface screen 302 may include any suitable displays and user interface buttons, lists, input regions, etc., for facilitating connection and identity verification across multiple touchpoints. For example, the touchpoint connection interface screen 302 may include an input for user account connection 308, and an input for user identity verification 310.

An example user engagement interface screen 304 may include any suitable displays and user interface buttons, lists, input regions, etc., for facilitating engagement such as driving continuous activations and offsetting rising customer acquisition costs (CAC). For example, the user engagement interface screen 304 may display information regarding membership tier and status 312.

An example user reward interface screen 306 may include any suitable displays and user interface buttons, lists, input regions, etc., for facilitating user rewards, such as providing access and exclusive rewards for increased lifetime value (LTV) of a customer. For example, the user reward interface screen 306 may display token gated access rewards 314.

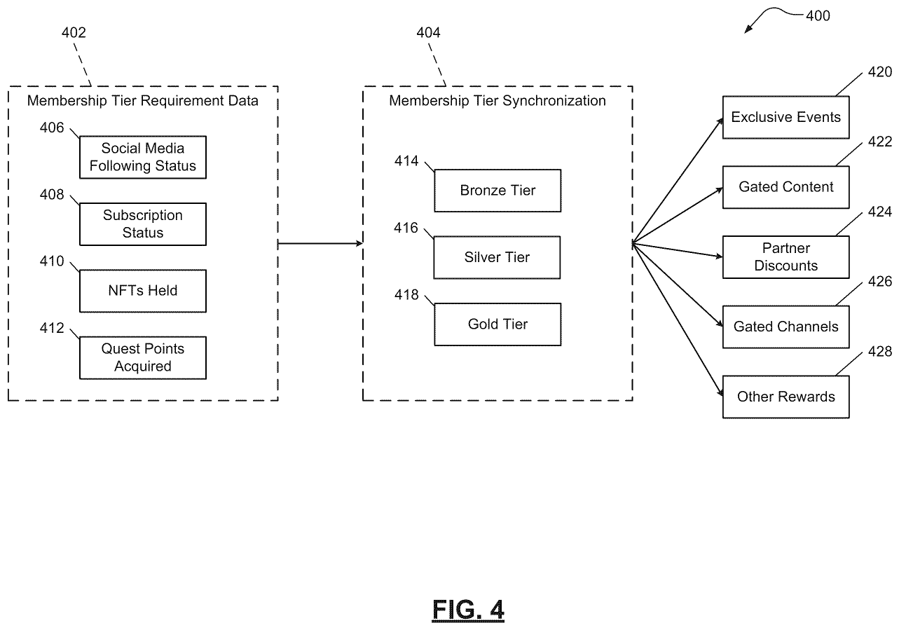

FIG. 4 is an illustration of example membership tiers 400 of the blockchain synchronized membership system of FIG. 1. For example, multiple criteria may be used to qualify for different membership tiers, such a social media following status, Substack subscriptions, holding specific NFTs, holding a specified number of quest points, etc.

A membership tier (e.g., bronze tier, silver tier, gold tier, etc.) may be assigned based on the qualifying criteria for the user. The membership tiers may be periodically synchronized/updated by the system 100 (such as every day, every week, etc.), and the membership tiers may grant access to various exclusive opportunities, such as exclusive events, gated content, partner discounts, gated channels.

In the example of FIG. 4, membership tier requirement data 402 may include any suitable data used to specify or determine whether members have met different membership tiers. Example data for determining whether members have met membership tier requirements may include, but is not limited to, social media following status 406, subscription status 408, specific non-fungible tokens (NFTs) held 410, and quest points acquired 412.

The system may provide automated membership tier synchronization 404, which may occur on a periodic interval (e.g., every second, every minute, hourly, daily, weekly, monthly, etc.). The membership tiers may include, but are not limited to, a bronze tier 414, a silver tier 416, and a gold tier 418.

The membership tiers may provide access to different rewards, which can be implemented via token gated access. For example, rewards may include, but are not limited to, exclusive events 420, gated content 422, partner discounts 424, gated channels 426, other rewards, 428, etc.

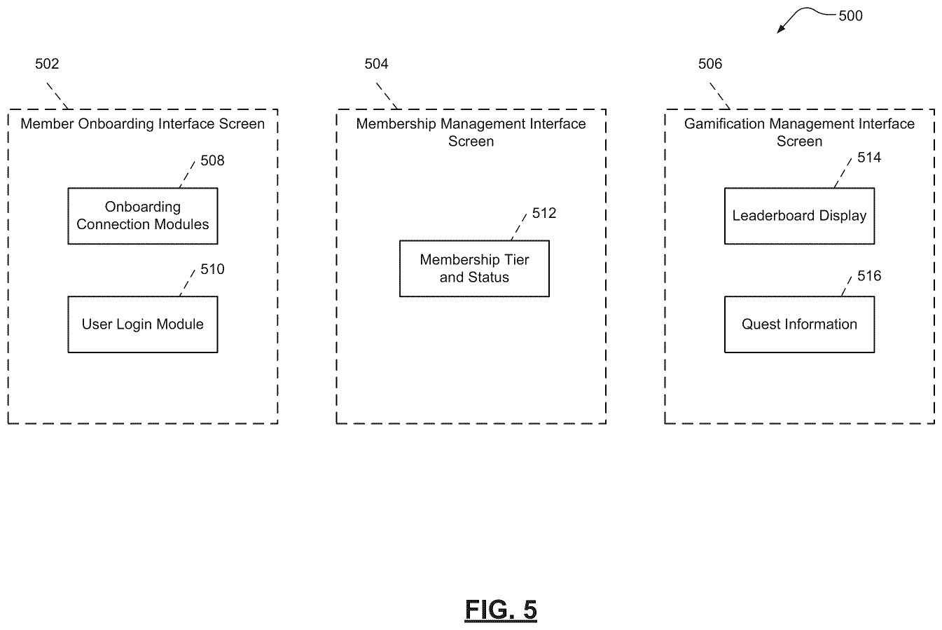

FIG. 5 is an illustration of example widgets 500 of a user interface for controlling a blockchain synchronized membership management system. For example, widgets displayed on a user interface may facilitate frictionless on-boarding, such as opt-in with no wallet required. FIG. 5 illustrates an example widget for connecting a wallet for a member, connecting a social media account, and connecting a Discord account.

A widget may facilitate management of memberships, such as auto-updating and kept-in-sync status for membership tiers. For example, FIG. 5 illustrates a member elevated to a gold membership tier after obtaining one-hundred experience points. The widgets may facilitate gamified engagement across every touchpoint, such as by displaying leaderboards, displaying opportunities to obtain additional experience points, etc.

The example of FIG. 5 includes a member onboarding interface screen 502, a membership management interface screen 504, and a gamification management interface screen 506, although other example embodiments may include more or less (or other) types of interface screens.

The member onboarding screen 502 may facilitate frictionless onboarding where new members can join without requiring a wallet for opt-in. The member onboarding screen 502 may include any suitable displays or user inputs, such as onboarding connection modules 508 (e.g., to connect to user social media accounts, optional wallet connections, etc.), and user login modules 510 for registering new members or logging in existing members.

The membership management interface screen 504 may facilitate automated membership management, which may include automatic updates to membership statuses that are kept in-sync. For example, the membership management interface screen 504 may include a display for membership tier and status 512, to let users see their current membership tier.

The gamification management interface screen 506 may facilitate gamified engagement for members, which may occur across one or more touchpoints. For example, the gamification management interface screen 506 may include a leaderboard display 514 to identify members having highest membership status or earning the most points, etc. The gamification management interface screen 506 may display quest information 516, such as additional subscriptions, social media account follows, NFTs to acquired, etc., to increase a membership tier or gain more points for the user.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer system for blockchain synchronized membership processing, the computer system comprising:
memory hardware configured to store blockchain data including a membership status blockchain, membership tier data including multiple membership tiers, membership token data including tokenized memberships each associated with one of multiple user entities, and computer-executable instructions; and
processor hardware configured to execute the computer-executable instructions to:
establish a communication connection with at least one membership system touchpoint;
define, in the membership tier data, one or more specified requirements associated with each of the multiple membership tiers;
grant tokenized memberships to multiple user entities according to user data associated with the multiple user entities, and the one or more specified requirements associated with each of the multiple membership tiers;
determine whether any of the multiple user entities have a changed membership status among the multiple membership tiers according to the one or more specified requirements;
in response to determining that one of the multiple user entities has a changed membership status, update a tokenized membership corresponding to the one of the multiple user entities having the changed membership status, on the membership status blockchain of the blockchain data; and
for each of the multiple user entities, grant access to one or more resources via token gating, according to one of the multiple membership tiers associated with a tokenized membership of the user entity.

2. The computer system of claim 1, wherein the processor hardware is configured to execute the computer-executable instructions to repeat checking whether any of the multiple user entities have a changed membership status among the multiple membership tiers, on a periodic interval.

3. The computer system of claim 2, wherein the periodic interval includes at least one of a daily interval and a weekly interval.

4. The computer system of claim 1, wherein the one or more specified requirements for the multiple membership tiers include at least one of ownership of one or more specified non-fungible tokens (NFTs), a following status on a social media account associated with the multiple membership tiers, a specified number of points obtained from defined quests associated with the multiple membership tiers, a subscription active status for a subscription service associated with the multiple membership tiers, completion of a specified purchase associated with the multiple membership tiers, or confirmed attendance at an event associated with the multiple membership tiers.

5. The computer system of claim 1, wherein the processor hardware is configured to execute the computer-executable instructions to define at least one quest represented by one or more actions executed by each one of the multiple user entities,
wherein each quest specifies at least one of a number of points that will be granted to one of the multiple user entities upon completion of the quest, a limit on whether the quest may be repeated, or a time period between successive completions of the quest.

6. The computer system of claim 1, wherein the processor hardware is configured to execute the computer-executable instructions to display one or more widgets on a user interface to facilitate changing system settings by a client user.

7. The computer system of claim 6, wherein the one or more widgets include at least one of:
a membership onboarding widget configured to connect at least one of an email account associated with one of the multiple user entities, a blockchain wallet associated with one of the multiple user entities, or a social media account associated with one of the multiple user entities;
a member dashboard widget configured to display at least one of membership tier information, points information, and steps needed to advance membership tiers;
a quests widget configured to identify determined actions for one of the multiple user entities to take to earn a specified number of points;
a leaderboard widget configured to display some of the multiple user entities on a leaderboard; or
a forms widget configured to collect information from one of the multiple user entities.

8. The computer system of claim 7, wherein the one or more widgets include all of the membership onboarding widget, the member dashboard widget, the quests widget, the leaderboard widget and the forms widget.

9. The computer system of claim 1, wherein the processor hardware is configured to execute the computer-executable instructions to adjust a number of non-fungible tokens (NFTs) held by one of the multiple user entities by burning at least one NFT and sending at least one new NFT to the one of the multiple user entities according to the one or more specified requirements associated with each of the multiple membership tiers.

10. The computer system of claim 9, wherein the multiple membership tiers are hierarchical and a single smart contract is linked for each one of the multiple user entities to facilitate token gating for each one of the multiple user entities.

11. The computer system of claim 1, wherein:
the processor hardware is configured to execute the computer-executable instructions to create and store a blockchain wallet for identifying membership in an organization; and
the blockchain wallet includes a combination of a private key and a public key.

12. The computer system of claim 1, wherein the processor hardware is configured to execute the computer-executable instructions to establish the communication connection with the at least one membership system touchpoint by plugging into a web application associated with the at least one membership system touchpoint.

13. The computer system of claim 1, wherein the processor hardware is configured to execute the computer-executable instructions to evaluate information of each of the multiple user entities by executing an authentication check and application programming interface (API) integration with one or more external systems.

14. The computer system of claim 13, wherein the processor hardware is configured onboard a new user entity by:
receiving a message satisfying an ERC-4361 standard to prove that the new user entity owns a blockchain wallet; and
executing a blockchain query to determine if user information of the new user entity satisfies specified member action definitions.

15. The computer system of claim 1, wherein the processor hardware is configured to execute the computer-executable instructions to implement the token gating by determining whether one of the multiple user entities has a specified threshold number of non-fungible tokens (NFTs) corresponding to a level of requested access.

16. A computerized method for blockchain synchronized membership processing, the computerized method comprising:
establishing a communication connection with at least one membership system touchpoint;
defining, in membership tier data, one or more specified requirements associated with each of multiple membership tiers;
granting tokenized memberships to multiple user entities according to user data associated with the multiple user entities, and the one or more specified requirements associated with each of the multiple membership tiers;
determining whether any of the multiple user entities have a changed membership status among the multiple membership tiers according to the one or more specified requirements;
in response to determining that one of the multiple user entities has a changed membership status, updating a tokenized membership corresponding to the one of the multiple user entities having the changed membership status, on a membership status blockchain; and
for each of the multiple user entities, granting access to one or more resources via token gating, according to one of the multiple membership tiers associated with a tokenized membership of the user entity.

17. The computerized method of claim 16, further comprising repeating checking of whether any of the multiple user entities have a changed membership status among the multiple membership tiers, on a periodic interval,
wherein the periodic interval includes at least one of a daily interval and a weekly interval.

18. The computerized method of claim 16, further comprising adjusting a number of non-fungible tokens (NFTs) held by one of the multiple user entities by burning at least one NFT and sending at least one new NFT to the one of the multiple user entities according to the one or more specified requirements associated with each of the multiple membership tiers.

19. The computerized method of claim 16, wherein the token gating is implemented by determining whether one of the multiple user entities has a specified threshold number of non-fungible tokens (NFTs) corresponding to a level of requested access.

20. A non-transitory computer-readable medium storing instructions that, when executed by at least one processor, cause the at least one processor to:
establish a communication connection with at least one membership system touchpoint;
define, in membership tier data, one or more specified requirements associated with each of multiple membership tiers;
grant tokenized memberships to multiple user entities according to user data associated with the multiple user entities, and the one or more specified requirements associated with each of the multiple membership tiers;
determine whether any of the multiple user entities have a changed membership status among the multiple membership tiers according to the one or more specified requirements;
in response to determining that one of the multiple user entities has a changed membership status, update a tokenized membership corresponding to the one of the multiple user entities having the changed membership status, on a membership status blockchain; and
for each of the multiple user entities, grant access to one or more resources via token gating, according to one of the multiple membership tiers associated with a tokenized membership of the user entity.
